(19) United States
(12) Patent Application Publication
(10) Pub. No.: US 2007/0169026 A1
(43) Pub. Date: Jul. 19, 2007

(54) Software program with alternative function libraries

(76) Inventor: Alan Howard Davis, Mountain View, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/287,819

(22) Filed: Nov. 28, 2005

(51) Int. Cl. G06F 9/45; G06F 9/44

(52) U.S. Cl. 717/140; 717/162

(57) ABSTRACT

A software program. The software program includes a function call. When the program is linked in a first mode, a first compiled routine from a first library is coupled to the function call. Otherwise, a second compiled routine from a second library is coupled to the function call. The first compiled routine is compiled from a source code routine with a parameter in the source code routine set to a first value, and the second compiled routine is compiled from the source code routine having the parameter in the source code routine set to a second value. The first compiled routine has same functionality as the second compiled routine plus additional functionality.

### BACKGROUND

In order to assess the performance of modern products with respect to conformance to their specifications, test and measurement has become an important part of product development and manufacturing life cycles. Test machines that perform these tests can be automated, often under computer control, to perform one or more of various tests on a variety of systems and/or components.

A user may need to write software programs as needed for performing such tests using these test machines. To ease the software programmer's efforts, the manufacturer of the test machine will often provide a library of common functions which can be used in the software program. As with all software programs, the program itself will need to be tested and modified as necessary to insure that it functions as designed. Finding and correcting errors which may exist in the program is referred to as debugging the program. In this effort, the program is often compiled in a debug mode wherein additional programming steps are added to the program that provide information to the software programmer for use in identifying the type and the program location of any errors. This can be, and often is, a time consuming and costly effort.

Once the software programmer is satisfied that the program is functioning correctly and ready for use, the program is recompiled without the additional programming steps used for debugging so that the speed at which the program performs its operations is increased. Often the software programmer does not check for various potential program problems such as stack overflow or errors which are reported to the software program by library functions. Thus, while the programmer may believe that the program is functioning correctly, it may not be under certain circumstances. Further, a problem with one of the library functions may be subsequently detected by the manufacturer and corrected in a later software release. Use of this new version of a library function, may then allow a program problem to surface which had not been previously detected by the software programmer or the user.

### SUMMARY

In representative embodiments, a software program is disclosed which comprises a function call. When the program is linked in a first mode, a first compiled routine from a first library is coupled to the function call. Otherwise, a second compiled routine from a second library is coupled to the function call. The first compiled routine is compiled from a source code routine with a parameter in the source code routine set to a first value, and the second compiled routine is compiled from the source code routine having the parameter in the source code routine set to a second value. The first compiled routine has the same functionality as the second compiled routine plus additional functionality.

In another representative embodiment, a pair of libraries are disclosed which comprise a first library and a second library. The first library comprises a first compiled routine, and the second library comprises a second compiled routine. The first compiled routine is compiled from a source code routine with a parameter in the source code routine set to a first value, and the second compiled routine is compiled from the source code routine with the parameter in the source code routine set to a second value. The first compiled routine has the same functionality as the second compiled routine plus additional functionality.

And in another representative embodiment, a method for creating a software program is disclosed. The method comprises specifying a mode in which to link the program, wherein the source code for the program comprises a function call. When a first mode is specified in the step specifying the mode, an executable form of the program is created by coupling object code for a first compiled routine from a first library to the function call in a previously compiled form of the program. Otherwise, the executable form of the program is created by coupling the object code for a second compiled routine from a second library to the function call in the previously compiled form of the program. The first compiled routine has the same functionality as the second compiled routine plus additional functionality.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of a block diagram of a test system as described in various representative embodiments.

FIG. 2A is a drawing of a block diagram of components and processes used in transforming program source code components into the executable software program as described in various representative embodiments.

FIG. 2B is a drawing of a block diagram of components and processes used by the software program in calling routines from one of two libraries as described in various representative embodiments.

FIG. 3 is a listing of a source code routine for the first and the second compiled routines as described in various representative embodiments.

FIG. 4 is a flow chart of a method for linking and running a program using alternative libraries as described in various representative embodiments.

### DETAILED DESCRIPTION

As shown in the drawings for purposes of illustration, novel techniques are disclosed herein for a software program that comprises calls to functions in alternative libraries which can be compiled in both a debug mode and in an operational mode. The debug mode compiled functions are provided in a debug library, and the operational mode compiled functions are provided in a separate library. The software program can then be linked or re-linked as necessary to either the debug library functions or the operational mode library functions as needed without recompiling the software program. Success or failure of the calls to library functions can be monitored without changing and recompiling the software program that the user developed. Previous techniques for such debugging have relied upon activating and/or adding debug code to the user developed software program with subsequent recompilation of the software program and linking.

In the following detailed description and in the several figures of the drawings, like elements are identified with like reference numerals.

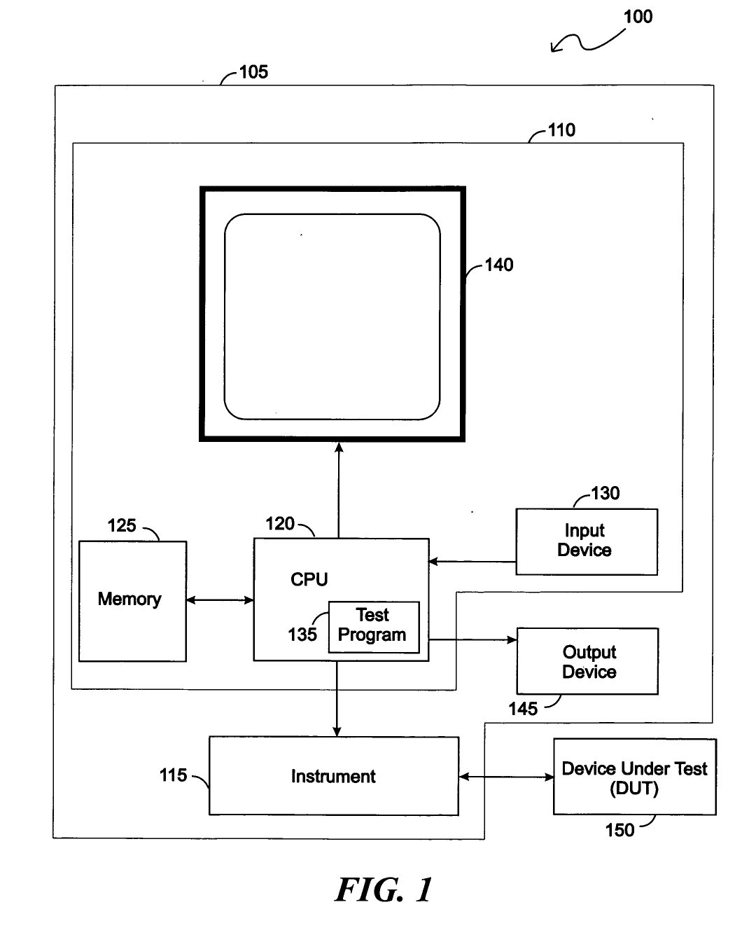

FIG. 1 is a drawing of a block diagram of a test system 100 as described in various representative embodiments. In FIG. 1, the test system 100 comprises a test machine 105 connected to a device under test (DUT) 150. The device under test (DUT) could be any of various types of electronic components 150 or any other type of component 150 such as a mechanical component 150. The test machine 105 comprises a computer 110 and an instrument 115. Also shown in FIG. 1 is an optional external output device 145 connected externally to the computer 110. The external output device 145 could be, for example, a printer 145. The computer 110 is connected to and controls the operation of the instrument 115 by setting the conditions under which the test measurement is performed, by actuating the measurement, and by collecting the results of the measurement. The instrument 115 shown in FIG. 1 can represent either a single instrument such as a voltmeter, current meter, or the like, or can represent a combination of individual instruments capable of a variety of measurements and measurement types.

The computer comprises a central processing unit (CPU) 120, a memory 125, an input device 130, and an internal output device 140. The input device 130 could be a keyboard 130, or a pointing device such as a pen, a mouse, a track point or a touch screen that is suitable for cursor manipulation or the like may be used. The internal output device 140 could be a monitor 140. The monitor 140 may be monochrome or color. The computer 110 can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system. In operation, an executable software test program 135, also referred to herein as a software test program 135 and as a test program 135 and also referred to herein in the general case as a software program 135 and as a program 135, may be loaded into the CPU 120 from the memory 125 or from an external source not shown in the Figures.

In other implementations, the test system 110 may comprise multiple CPUs 120 not all of which may be performing the same test function and which may be attached to other input/output devices and which may not be attached to the various input/output devices shown in FIG. 1.

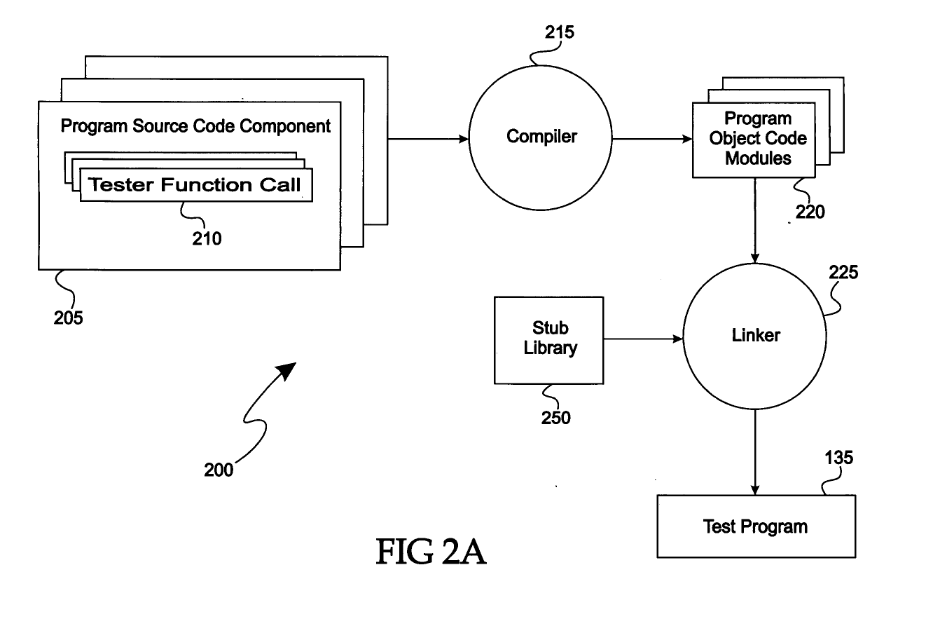

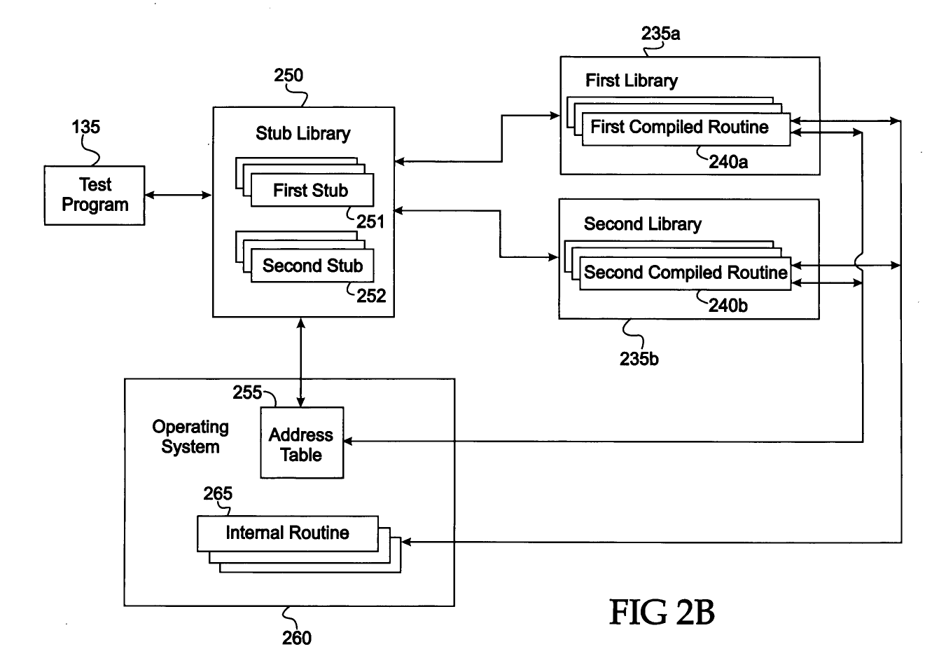

FIG. 2A is a drawing of a block diagram of components and processes 200 used in transforming program source code components 205 into the executable software program 135 as described in various representative embodiments. In FIG. 2A, a compiler 215 compiles program source code components 205 into program object code modules 220. The program source code components 205 include tester function calls 210, also referred to herein in the general case as function calls 210, which are calls to functions standard to the test machine 105 and which are found in a library of such functions. The library of such functions is typically provided by the manufacturer of the test machine 105, whereas the program source code routines are created by the user of the test machine 105 for the user's particular purpose. A linker 225 combines or links the program object code modules 220 with a stub library 250 which, as will be shown in FIG. 2B, can be used to couple object code for library routines. Techniques other than the use of the stub library 250, such as a direct coupling of the compiled tester routines 240a,240b to the function calls 210 in the program 135, can be used in satisfying the function calls 210.

FIG. 2B is a drawing of a block diagram of components and processes used by the software program 135 in calling routines from one of two libraries 235a,235b as described in various representative embodiments. Referring to both FIG. 2A and FIG. 2B, the linker 225 creates the executable software test program 135 in one of two forms referred to herein as modes. When the executable software test program 135 is linked in a debug mode, also referred to herein as a first mode in the general case, the tester function calls 210 are coupled to first compiled tester routines 240a from a debug library 235a. First compiled tester routines 240a are referred to herein as first compiled routines 240a in the general case, and the debug library 235a is referred to herein as the first library 235a in the general case. Otherwise, when the executable software test program 135 is linked in an operational mode, also referred to herein as a second mode in the general case, the tester function calls 210 are replaced by second compiled tester routines 240b from an operational library 235b. Second compiled tester routines 240b are referred to herein as second compiled routines 240b in the general case, and the operational library 235b is referred to herein as the second library 235b in the general case. Thus, depending upon the mode selected when linking the software test program 135, compiled tester routines 240 from one of two libraries 235a,235b are coupled to the software test program 135.

In practice, a call to the tester function call 210 is satisfied via a stub library 250 which is typically located in an operating system 260 of the computer 110 and which uses a first stub 251 to obtain the address of the first compiled tester routine 240a in the first library 235a from an address table 255 or uses a second stub 252 to obtain the address of the second compiled tester routine 240b in the second library 235b from the address table 255 depending upon the mode chosen at link time by the user. The first compiled tester routine 240a has functionality additional to functionality of the second compiled tester routine 240b. In representative embodiments, the additional functionality of the first compiled tester routine 240a provides information for debugging the software test program 135. First and second compiled routines 240a,240b make calls to internal routines 265 located in the operating system 260. Techniques disclosed herein are applicable to software programs 135 with multiple function calls 210 of various types. Other techniques, as for example linking one of the compiled tester routines 240a,240b with the program object code modules 220 at link time, could also be used rather than the use of the stub library 250. Techniques other than the use of the stub library 250 and the address table 255 can be used in satisfying the function calls 210. However, the stub library 250 with function address look-up in the address table 255 facilitates calls to routines independent of the revision of the operating system used.

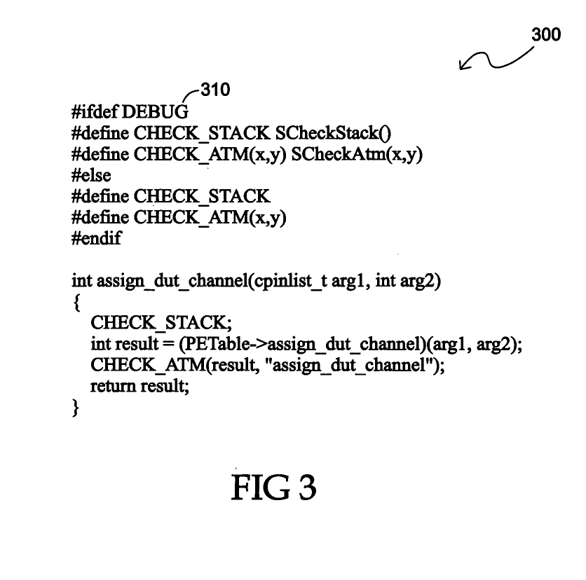

FIG. 3 is a listing of a source code routine 300 for the first and the second compiled routines 240a,240b as described in various representative embodiments. The second compiled tester routine 240b is compiled from the source code routine 300 having a parameter 310 which in this representative example is “DEBUG” in the source code routine 300 set to a second value which in this representative example is NULL. The first compiled tester routine 240a is compiled from the source code routine 300 with the parameter 310 in the source code routine 300 set to a first value resulting in the first compiled tester routine 240a having functionality additional to functionality of the second compiled tester routine 240b. Again, in this representative example the parameter 310 is “DEBUG”, but for compilation of the first compiled tester routine 240a, the value of DEBUG has a non-NULL value.

The functionality in the first compiled tester routine 240a in addition to that found in the second compiled tester routine 240b includes a check of the stack at initiation of the routine via the call to “SCheckStack( )” and a check of the return value of the routine “PETable( )” internal to the first compiled tester routine 240a via the call to “SCheckAtm( )”. Whereas, the functionality in the second compiled tester routine 240b does not include the check of the stack at initiation of the routine via the call to “SCheckStack( )” as “CHECK_STACK” compiles to NULL rather than to “SCheckStack( )” as for the first compiled tester routine 240a. Also, the functionality in the second compiled tester routine 240b does not include a check of the return value of the routine “PETable( )” which is internal to the first compiled tester routine 240a via the call to “SCheckAtm( )” as “CHECK_ATM” compiles to NULL rather than to “SCheckAtm( )” as for the first compiled tester routine 240a.

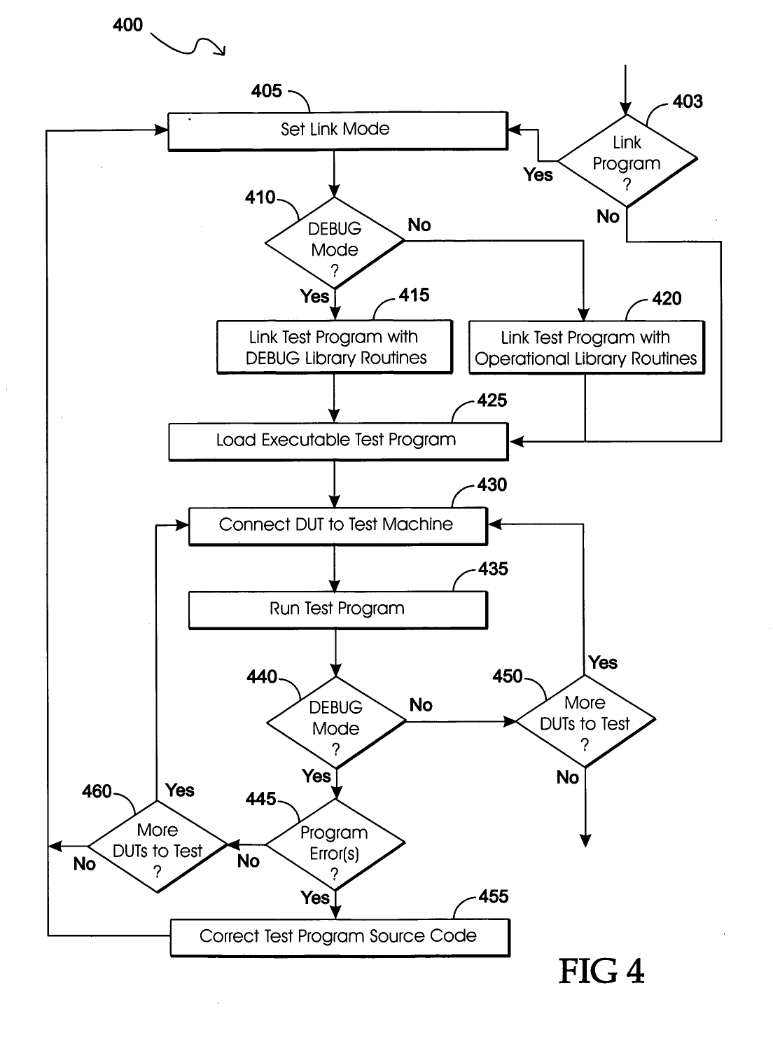

FIG. 4 is a flow chart of a method 400 for linking and running a program 135 using alternative libraries 235a,235b as described in various representative embodiments. In block 403, if the program 135 is to be linked or re-linked, block 403 transfers control to block 405. Otherwise, block 403 transfers control to block 425.

In block 405, the mode for linking program source code components 205 with either the debug library (the first library) 235a or the operational library (the second library) is set by the user. Block 405 then transfers control to block 410.

If the debug mode was selected in block 405, block 410 transfers control to block 415. Otherwise, block 405 transfers control to block 420.

In block 415, the test program 135 is linked with the appropriate first compiled tester routines 240a in the debug library 235a to create the executable software test program 135. Block 415 then transfers control to block 425.

In block 420, the test program 135 is linked with the appropriate second compiled tester routines 240b in the operational library 235b to create the executable software test program 135. Block 420 then transfers control to block 425.

In block 425, the executable software test program 135 created in either block 415 or block 420 is loaded into the CPU 120 of the test machine's 105 computer 110. Block 425 then transfers control to block 430.

In block 430, the device under test 150 is connected to the test machine 105. Block 430 then transfers control to block 435.

In block 435, the executable software test program 135 is activated in the CPU 120 of the test machine's 105 computer 110 in order run the test on the device under test 150. Block 435 then transfers control to block 440.

If the debug mode was selected in block 405, block 440 transfers control to block 445. Otherwise, block 440 transfers control to block 450.

If program error(s) were found while running the program 135 in block 435, block 445 transfers control to block 455. Otherwise, block 445 transfers control to block 460.

If it is determined in block 450 that there are more DUTs 150 to test, block 450 transfers control to block 430. Otherwise, block 450 terminates the process.

In block 455, errors in the program source code components 205 are corrected. Block 455 then transfers control to block 405.

If it is determined in block 460 that there are more DUTs 150 to test, block 460 transfers control to block 430. Otherwise, block 460 terminates control to block 405.

Once no further errors are found when running the test program 135 and the program 135 is re-linked in operational mode, blocks 425, 430, and 435 can be run as appropriate without looping through the other steps in FIG. 4. However, the decision made in block 403 leads the user to blocks 425, 430, and 435, and the decisions made in blocks 440 and 450 lead the user out of and back to blocks 425, 430, and 435 as appropriate.

In representative embodiments, a software program 135 is disclosed which comprises a function call 210. When the program 135 is linked in a first mode, a first compiled routine 240a from a first library 235a is coupled to the function call 210. Otherwise, a second compiled routine 240b from a second library 235b is coupled to the function call 210. The first compiled routine 240a is compiled from a source code routine 300 with a parameter 310 in the source code routine 300 set to a first value, and the second compiled routine 240b is compiled from the source code routine 300 having the parameter 310 in the source code routine 300 set to a second value. The first compiled routine 240a has same functionality as the second compiled routine 240b plus additional functionality.

In another representative embodiment, a pair of libraries 235a,235b are disclosed which comprise a first library 235a and a second library 235b. The first library 235a comprises a first compiled routine 240a, and the second library 235b comprises a second compiled routine 240b. The first compiled routine 240a is compiled from a source code routine 300 with a parameter 310 in the source code routine 300 set to a first value, and the second compiled routine 240b is compiled from the source code routine 300 having the parameter 310 in the source code routine 300 set to a second value. The first compiled routine 240a has the same functionality as the second compiled routine 240b plus additional functionality.

And in another representative embodiment, a method 400 for creating a software program 135 is disclosed. The method comprises specifying a mode in which to link the program 135, wherein the source code for the program 135 comprises a function call 210. When a first mode is specified in the step specifying the mode, an executable form of the program 135 is created by coupling object code for a first compiled routine 240a from a first library 235a to the function call 210 in a previously compiled form of the program 135. Otherwise, the executable form of the program 135 is created by coupling the object code for a second compiled routine 240b from a second library 235b to the function call 210 in the previously compiled form of the program 135. The first compiled routine 240a has the same functionality as the second compiled routine 240b plus additional functionality.

As is the case, in many data-processing products, the systems described above may be implemented as a combination of hardware and software components. Moreover, the functionality required for use of the representative embodiments may be embodied in computer-readable media (such as floppy disks, conventional hard disks, DVDs, CD-ROMs, Flash ROMs, nonvolatile ROM, and RAM) to be used in programming the computer 110 of a test machine 105.

The term “program storage medium” is broadly defined herein to include any kind of computer memory such as, but not limited to, floppy disks, conventional hard disks, DVDs, CD-ROMs, Flash ROMs, nonvolatile ROM, and RAM.

In a representative embodiment of the software programs 135 and methods disclosed herein, the user writes a program in which calls are made to library routines. These calls can be satisfied from compiled tester routines found in one of two alternative libraries 235a,235b. The routines in the first 235a of these libraries provide the user additional information regarding the operation of the routines and are typically used for debugging a software program 135 which could be, for example, a software test program 135. The routines in the second 235b of these libraries are the same as the routines in the first library 235a devoid of this additional information. In fact, the source code for both versions of the compiled routines 240a,240b is the same except for the value of a parameter 310. The value of the parameter 310 is used as a control during compilation of the first and second compiled routines 240a,240b thereby enabling selected operational checking and other functions, such as reporting of values at intermediate points in the running of the program 135 by the compiled versions of the first library routines 235a. Program confirmation and debugging of test programs 135 with newly released library functions is simplified as the source code for the software test program 135 does not need to be recompiled. The source code for the software test program 135 needs only to be linked with the debug library (the first library) 235a during debug and then re-linked with the operational library (the second library) 235b once appropriate operation of the software program 135 has been confirmed.

While the discussion herein has been in terms of software test programs 135 for testing electronic components 150, it will be recognized by one skilled in the art that the techniques disclosed herein are not limited to such software programs 135. The same function calls are made by the software program 135 regardless of which library 235a,235b is used to satisfy the calls. In addition, by not recompiling the code which the user writes but only that which is provided by the manufacturer of the test machine 105, the compiled code that is changed is limited to that provided by the manufacturer thereby reducing confusion as to the source of any problem and reducing the possibility of changes in code by the user from introducing additional problems.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A software program, comprising:
a function call,
wherein,
when the program is linked in a first mode: a first compiled routine from a first library is coupled to the function call,
otherwise: a second compiled routine from a second library is coupled to the function call,
wherein the first compiled routine is compiled from a source code routine with a parameter in the source code routine set to a first value,
wherein the second compiled routine is compiled from the source code routine having the parameter in the source code routine set to a second value, and
wherein the first compiled routine has same functionality as the second compiled routine plus additional functionality.

2. The software program as recited in claim 1, wherein the additional functionality of the first compiled routine is configured to provide information for debugging the program.

3. The software program as recited in claim 1, wherein the program is configured to run on a test machine.

4. The software program as recited in claim 1, wherein the program is configured to test a component.

5. The software program as recited in claim 1, wherein the program is configured to run on a test machine and is configured to test a component.

6. The software program as recited in claim 1,
wherein when the program is linked in the first mode and when the executable form of the program is executed:
a call to the first compiled routine comprises:
a call to a first stub in a stub library, wherein the first stub looks up the address of the first compiled routine in an address table and subsequently redirects the call to the first compiled routine to that address;
otherwise when the program is linked in the second mode and when the executable form of the program is executed:
a call to the second compiled routine comprises:
a call to a second stub in the stub library, wherein the second stub looks up the address of the second compiled routine in the address table and subsequently redirects the call to the second compiled routine to that address.

7. A pair of libraries, comprising:
a first library comprising a first compiled routine;
a second library comprising a second compiled routine, wherein the first compiled routine is compiled from a source code routine with a parameter in the source code routine set to a first value, wherein the second compiled routine is compiled from the source code routine having the parameter in the source code routine set to a second value, and wherein the first compiled routine has the same functionality as the second compiled routine plus additional functionality.

8. The pair of libraries as recited in claim 7, wherein the additional functionality of the first compiled routine is configured to provide information for debugging a program which calls the first compiled routine.

9. The pair of libraries as recited in claim 8, wherein the program is configured to test a component.

10. The pair of libraries as recited in claim 7, wherein the first compiled routine and the second compiled routine are configured to support test of a component.

11. The pair of libraries as recited in claim 7, wherein the first compiled routine and the second compiled routine are configured to support execution of a program to test a component on a test machine.

12. The pair of libraries as recited in claim 7, wherein the first compiled routine and the second compiled routine are configured to support test of a component and are configured to support execution of a program to test the component on a test machine.

13. A method for creating a software program, comprising:
specifying a mode in which to link the program, wherein the source code for the program comprises a function call; and
when a first mode is specified in the step specifying the mode:
creating an executable form of the program by coupling object code for a first compiled routine from a first library to the function call in a previously compiled form of the program,
otherwise:
creating the executable form of the program by coupling the object code for a second compiled routine from a second library to the function call in the previously compiled form of the program, wherein the first compiled routine has the same functionality as the second compiled routine plus additional functionality.

14. The method as recited in claim 13, wherein the additional functionality of the first compiled routine is configured to provide information for debugging the program.

15. The method as recited in claim 13, wherein the program is configured to run on a test machine.

16. The method as recited in claim 13, wherein the program is configured to test a component.

17. The method as recited in claim 13, wherein the program is configured to run on a test machine and to test a component.

18. The method as recited in claim 13, further comprising:
loading the executable form of the program into a computer; and
running the executable form of the program.

19. The method as recited in claim 18, further comprising:
prior to the step running the program, connecting a component to a test machine, wherein the test machine comprises the computer.

20. The method as recited in claim 18,
wherein when the program is linked in the first mode, the step running the executable form of the program comprises:
calling the first compiled routine, wherein calling the first compiled routine comprises:
calling a first stub in a stub library, wherein calling the first stub comprises:
looking up the address of the first compiled routine in an address table and
calling the first compiled routine in the first library;
otherwise when the program is linked in the second mode, the step running the executable form of the program comprises:
calling the second compiled routine, wherein calling the second compiled routine comprises:
calling a second stub in the stub library, wherein calling the second stub comprises:
looking up the address of the second compiled routine in the address table and
calling the second compiled routine in the second library.
